(19) United States
(12) Patent Application Publication
(10) Pub. No.: US 2026/0243904 A1
(43) Pub. Date: Aug. 20, 2026

(54) METHOD AND APPARATUS FOR GLOBAL NAVIGATION SATELLITE SYSTEM (GNSS) POSITIONING MEASUREMENT

(71) Applicant: Beijing Xiaomi Mobile Software Co., Ltd., Beijing (CN)

(72) Inventor: Yajun ZHU, Beijing (CN)

(73) Assignee: Beijing Xiaomi Mobile Software Co., Ltd., Beijing (CN)

(21) Appl. No.: 18/876,621

(22) PCT Filed: Jun. 24, 2022
(86) PCT No.: PCT/CN2022/101332

§ 371 Date: Dec. 18, 2024

(51) Int. Cl. G01S 19/42; H04W 74/0833

(52) U.S. Cl. CPC G01S 19/42; H04W 74/0833

(57) ABSTRACT

A method and an apparatus for global navigation satellite system (GNSS) positioning measurement. The GNSS positioning measurements are performed by: receiving a paging message sent by a network device; where the paging message includes first indication information, and the first indication information is configured to determine time domain range information for the terminal device to perform positioning measurement; and performing, according to the first indication information, the positioning measurement within a time domain range.

### CROSS-REFERENCE

The present application is a U.S. National Stage of International Application No. PCT/CN2022/101332, filed on Jun. 24, 2022, the entire content of which is incorporated herein by reference for all purposes.

### TECHNICAL FIELDS

The present disclosure relates to a field of communication technology, particularly a method and apparatus for global navigation satellite system GNSS positioning measurement.

### BACKGROUND

In the scenario of satellite communication, due to the long distance of signal transmission and the long time of data transmission, parameters for compensating transmission latency are introduced for transmissions with uplink and downlink relationships. A terminal device needs to acquire its own position information to facilitate uplink synchronization compensation.

In the related art, when the terminal device enters an idle state when acquiring Global Navigation Satellite System (GNSS) information, when a network device needs to page the terminal device, if the terminal device is unable to complete the GNSS measurement in time, it is unable to respond to the page in time, resulting in unnecessary expansion of the paging region and increased signaling overhead.

### SUMMARY

A first aspect of embodiments of the present disclosure proposes a method for global navigation satellite system GNSS positioning measurement, performed by a terminal device and including:
receiving a paging message sent by a network device;
where the paging message includes first indication information, and the first indication information is configured to determine time domain range information for the terminal device to perform positioning measurement; and
performing, according to the first indication information, the positioning measurement within a time domain range.

A second aspect of embodiments of the present disclosure proposes a method for global navigation satellite system GNSS positioning measurement, performed by a network device and including:
sending a paging message to a terminal device;
where the paging message includes first indication information, and the first indication information is configured to determine time domain range information for the terminal device to perform positioning measurement.

A third aspect of embodiments of the present disclosure proposes a communication apparatus, including a processor and a memory, where the memory stores a computer program, and the processor executes the computer program stored in the memory to cause the apparatus to perform the method for global navigation satellite system GNSS positioning measurement according to the embodiments of the first aspect.

A fourth aspect of embodiments of the present disclosure proposes a communication apparatus, including a processor and a memory, where the memory stores a computer program, and the processor executes the computer program stored in the memory to cause the apparatus to perform the method for global navigation satellite system GNSS positioning measurement according to the embodiments of the second aspect.

Additional aspects and advantages of the present disclosure will be partially presented in the following description, some of which will become apparent from the following description, or learned through practice of the present disclosure.

### BRIEF DESCRIPTION OF THE DRAWINGS

In order to more clearly illustrate technical solutions of embodiments or background technology of the present disclosure, the accompanying drawings required for use in the embodiments or background technology of the present disclosure will be described below.

FIG. 1a is a schematic diagram of an architecture of a communication system provided in an embodiment of the present disclosure;

FIG. 1b is a schematic diagram of a timing alignment data transmission of uplink and downlink of a network device side;

FIG. 1c is a schematic diagram of a timing misaligned data transmission of uplink and downlink of a network device side;

FIG. 2 is a flowchart of a method for GNSS positioning measurement provided in an embodiment of the present disclosure;

FIG. 3 is a flowchart of a method for GNSS positioning measurement provided in an embodiment of the present disclosure;

FIG. 4 is a flowchart of a method for GNSS positioning measurement provided in an embodiment of the present disclosure;

FIG. 5 is a flowchart of a method for GNSS positioning measurement provided in an embodiment of the present disclosure;

FIG. 6a is a schematic diagram of a method for GNSS positioning measurement provided in an embodiment of the present disclosure;

FIG. 6b is a schematic diagram of a method for GNSS positioning measurement provided in an embodiment of the present disclosure;

FIG. 6c is a schematic diagram of a method for GNSS positioning measurement provided in an embodiment of the present disclosure;

FIG. 7 is a flowchart of a method for GNSS positioning measurement provided in an embodiment of the present disclosure;

FIG. 8 is a structural diagram of an apparatus for GNSS positioning measurement provided in an embodiment of the present disclosure;

FIG. 9 is a structural diagram of an apparatus for GNSS positioning measurement provided in an embodiment of the present disclosure;

FIG. 10 is a structural diagram of another apparatus for GNSS positioning measurement provided in an embodiment of the present disclosure;

FIG. 11 is a structural diagram of a chip provided in an embodiment of the present disclosure.

### DETAILED DESCRIPTION

Embodiments of the present disclosure are described in detail below, examples of which are illustrated in the accompanying drawings. When the following descriptions refer to the accompanying drawings, same numbers in different drawings represent same or similar elements unless otherwise indicated. The implementations described in the following exemplary embodiments do not represent all implementations consistent with embodiments of the present disclosure. Rather, they are merely examples of apparatuses and methods consistent with some aspects of the present disclosure as detailed in the appended claims.

The terms described in the embodiments of the present disclosure are only for the purpose of describing specific embodiments and are not intended to limit the embodiments of the present disclosure. The singular forms “a,” “the” used in the embodiments of the present disclosure and the appended claim are also intended to include plural forms, unless the context clearly indicates otherwise. It should also be understood that the term “and/or” used in the present disclosure means and includes any or all possible combinations of one or more associated listed items.

It should be understood that, although the terms first, second, third, etc. may be used in embodiments of the present disclosure to describe various information, such information shall not be limited to these terms. These terms are only used to distinguish the same category of information. For example, subject to the scope of embodiments of the present disclosure, first information may also be referred to as second information, and similarly, second information may also be referred to as first information. It depends on the context. For example, the word “in case of,” “if” as used herein may be interpreted as “in a case that” or “when” or “in response to determining”.

Embodiments of the present disclosure are described in detail below, examples of which are illustrated in the drawings. The same or similar elements are denoted by same reference numerals in different drawings unless indicated otherwise. The embodiments described herein with reference to drawings are explanatory, and used to generally understand the present disclosure. The embodiments shall not be construed to limit the present disclosure.

In order to better understand a method for global navigation satellite system GNSS positioning measurement disclosed in the embodiments of the present disclosure, a communication system applicable to the embodiments of the present disclosure will be described below.

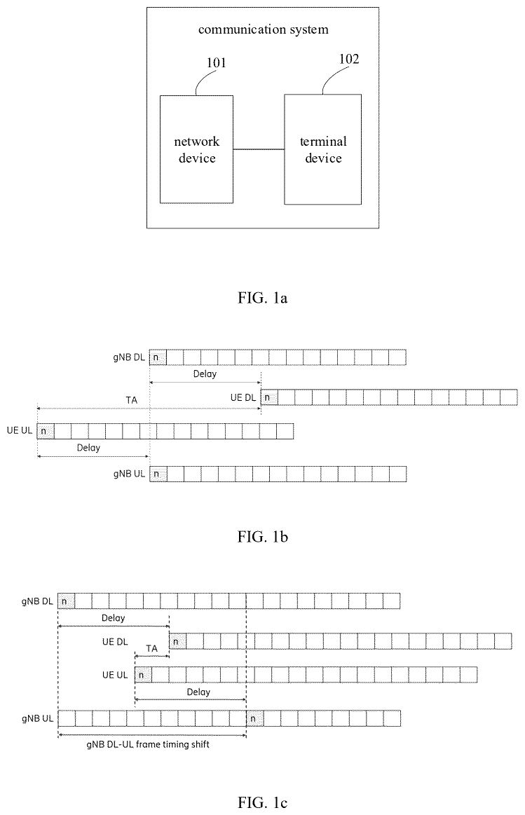

Referring to FIG. 1a, FIG. 1a is a schematic diagram illustrating an architecture of a communication system provided in an embodiment of the present disclosure. The communication system may include, but is not limited to, one network device and one terminal device. A number and a form of devices as illustrated in FIG. 1 are for example only and do not constitute a limitation to embodiments of the present disclosure. In practical applications, the system may include two or more network devices and two or more terminal devices. The communication system as illustrated in FIG. 1 takes including one network device 101 and one terminal device 102 as an example.

It should be noted that the technical solution of embodiments of the present disclosure may be applied to various communication systems, for example, a long term evolution (LTE) system, a 5th generation (5G) mobile communication system, a 5G new radio (NR) system, or other future new mobile communication systems.

The network device 101 in embodiments of the present disclosure is a physical device for transmitting or receiving signals on a network side. For example, the network device 101 may be an evolved NodeB (eNB), a transmission reception point (TRP), a next generation NodeB (gNB) in an NR system, base stations in other future mobile communication systems, or access nodes in wireless fidelity (WiFi) systems. Embodiments of the present disclosure do not limit a specific technology and a specific device form adopted by the network device. The network device provided in embodiments of the present disclosure may be composed of a central unit (CU) and a distributed unit (DU). The CU may also be referred to as a control unit. The network device, such as a protocol layer of a base station, may be separated through a CU-DU structure. Some functions in the protocol layer may be controlled centrally by the CU, and the remaining or all functions in the protocol layer may be distributed within the DU which is centrally controlled by the CU.

The terminal device 102 in embodiments of the present disclosure is physical device for receiving or transmitting signals on a user side, such as a mobile phone. The terminal device may also be referred to as a terminal, a user equipment (UE), a mobile station (MS), a mobile terminal (MT), etc. The terminal device may be a vehicle with a communication feature, a smart vehicle, a mobile phone, an internet of things (IoT) terminal, a wearable device, a pad, a computer with a wireless transceiver feature, a virtual reality (VR) terminal, an augmented reality (AR) terminal, a wireless terminal in industrial control, and a wireless terminal in self-driving, a wireless terminal in remote medical surgery, a wireless terminal in smart grid, a wireless terminal in transportation safety, a wireless terminal in smart city, and a wireless terminal in smart home.

The embodiments of the present disclosure do not limit a specific technology and a specific device form adopted by the terminal device.

With the continuous development of wireless communication technology, satellite communication is considered an important aspect of the future development of wireless communication technology. In the scenario of satellite communication, due to the long signal transmission distance between a transmitter and a receiver, there is a significant latency in data transmission. For transmissions with uplink and downlink relationships, the current standardization discussion has determined the introduction of the offset Koffset parameter to compensate for transmission latency. As shown in FIG. 1b and FIG. 1c, FIG. 1b is a schematic diagram of a timing alignment data transmission of uplink and downlink of a network device side, and FIG. 1c is a schematic diagram of a timing misaligned data transmission of uplink and downlink of a network device side.

The terminal device may compensate the transmission latency through ephemeris information and common timing advance (common TA) related information. The ephemeris information and common TA information are notified to the terminal device through system information.

In the scenario of satellite communication, the terminal device needs to acquire its own position information to facilitate uplink synchronization compensation. During the transmission of services with a relatively long transmission duration, if the Global Navigation Satellite System (GNSS) information expires, the terminal device needs to re-acquire the GNSS information.

In the related art, when the terminal device enters an idle state when acquiring the GNSS information, when a network device needs to page the terminal device, if the terminal device is unable to complete the GNSS measurement in time, it is unable to respond to the page in time, resulting in unnecessary expansion of the paging region and increased signaling overhead.

It may be understood that, the communication system described in embodiments of the present disclosure are intended to explain technical solutions of embodiments of the present disclosure more clearly, and does not constitute a limitation to the technical solutions provided by embodiments of the present disclosure. Those skilled in the art know that, with evolution of a system architecture and emergence of a new business scenario, the technical solutions provided in embodiments of the present disclosure are equally applied to similar technical problems.

A method and an apparatus for global navigation satellite system GNSS positioning measurement provided in the present disclosure are described below, in conjunction with the accompanying drawings.

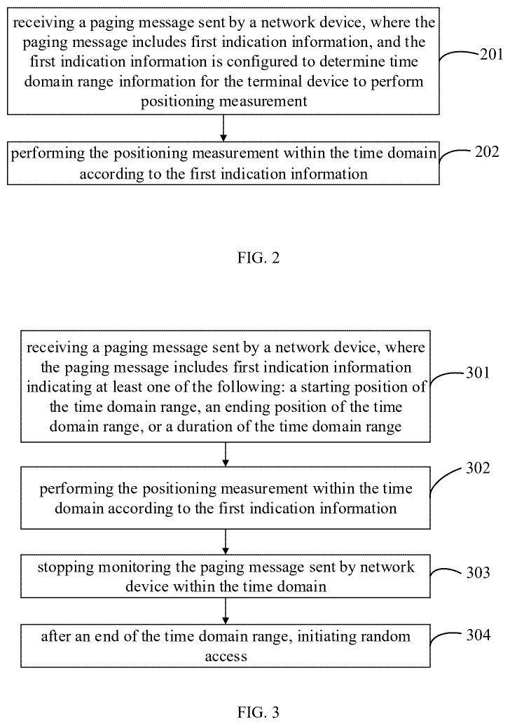

Referring to FIG. 2, FIG. 2 is a flowchart of a method for GNSS positioning measurement provided in an embodiment of the present disclosure. It should be noted that the method for the global navigation satellite system GNSS positioning measurement of the embodiment of the present disclosure is performed by a terminal device. The method may be performed independently or in combination with any other embodiment of the present disclosure. As shown in FIG. 2, the method may include the following steps 201-202:
in step 201: a paging message sent by a network device is received, the paging message includes first indication information, and the first indication information is configured to determine time domain range information for the terminal device to perform positioning measurement.

In the embodiment of the present disclosure, the terminal device receives the paging message sent by the network device and performs the positioning measurement after receiving the paging message. It should be noted that in the embodiments of the present disclosure, the terminal device is in an idle state.

The paging message includes the first indication information, which is configured to determine time domain range information when the terminal device performs the positioning measurement. That is, the terminal device is able to perform the positioning measurement within the time domain range determined by the first indication information.

In some embodiments, the first indication information is configured to indicate at least one of the following: a starting position of the time domain range, an ending position of the time domain range, or a duration of the time domain range. The terminal device may determine the time domain range for performing positioning measurement according to the first indication information.

In some embodiments, the terminal device may initiate random access after an end of the time domain range. That is, after the end of the time domain range, the terminal device sends a random access message to the network device.

In some embodiments, the first indication information is configured to indicate a time domain position of a first random access occasion (RACH Occasion, RO), where RACH refers to Random Access Channel. A starting position of the time domain range determined according to the first indication information is a time domain position where the paging message is received, and an ending position of the time domain range is the time domain position of the first random access occasion.

In some embodiments, the terminal device may initiate random access on the first RO. That is, the terminal device may send a random access message to the network device on the first RO.

In some embodiments, the first indication information is configured to indicate time domain positions of a plurality of random access occasions. A starting position of the time domain range determined according to the first indication information is a time domain position where the paging message is received, and an ending position of the time domain range is the time domain position of the last one RO of the plurality of ROs.

In some embodiments, the terminal device may initiate random access on a first one random access occasion after completing the positioning measurement. That is, the terminal device may send a random access message to the network device on the first one RO among the plurality of ROs after the positioning measurement is completed.
in step 202: the positioning measurement is performed within the time domain according to the first indication information.

In the embodiments of the present disclosure, the terminal device may perform the positioning measurement within the time domain range determined by the first indication information according to the first indication information. The terminal device may perform the positioning measurement on any time domain position within the time domain range according to its own positioning measurement capability and implementation situation.

In the embodiments of the present disclosure, the terminal device may stop monitoring the paging message sent by the network device within the time domain range determined by the first indication information.

In summary, the paging message sent by the network device is received, the paging message includes the first indication information, which is configured to determine the time domain range information for the terminal device to perform positioning measurement, and according to the first indication information, the positioning measurement is performed within the time domain range, such that the terminal device may timely and effectively acquire its own position information in the idle state, thereby effectively reducing transmission latency, saving power consumption of the terminal device, and avoiding unnecessary paging signaling overhead caused by the terminal device not responding to the paging message in time, which effectively saves the signaling overhead of the system and improves the communication efficiency of the system.

Referring to FIG. 3, which is a flowchart of a method for global navigation satellite system GNSS positioning measurement provided in an embodiment of the present disclosure. It should be noted that the method for global navigation satellite system GNSS positioning measurement of the embodiment of the present disclosure is performed by a terminal device. The method may be performed independently or in combination with any other embodiment of the present disclosure. As shown in FIG. 3, the method may include the following steps 301-304:
in step 301: a paging message sent by a network device is received, the paging message includes first indication information indicating at least one of the following: a starting position of the time domain range, an ending position of the time domain range, or a duration of the time domain range.

In the embodiment of the present disclosure, the terminal device receives a paging message sent by the network device and performs the positioning measurement after receiving the paging message. It should be noted that in the embodiments of the present disclosure, the terminal device is in an idle state.

The paging message includes first indication information, and the first indication information is configured to indicate at least one of the following:
a starting position of the time domain range where the terminal device performs the positioning measurement, an ending position of the time domain range where the terminal device performs the positioning measurement, or a duration of the time domain range where the terminal device performs the positioning measurement.

The terminal device may determine the time domain range for performing the positioning measurement according to the first indication information.

In step 302, the positioning measurement is performed within the time domain according to the first indication information.

In the embodiment of the present disclosure, the terminal device performs the positioning measurement within the time domain determined according to the first indication information in the paging message after receiving the paging message.

In the embodiments of the present disclosure, the terminal device may perform the positioning measurement on any time domain position within the time domain range according to its own capability and implementation situation.

In step 303: monitoring of the paging message sent by network device within the time domain is stopped.

In the embodiment of the present disclosure, the terminal device may stop monitoring the paging message sent by the network device within the time domain range determined by the first indication information in the paging message, and no longer receive the paging message sent by the network device within the time domain range.

In step 304: after an end of the time domain range, random access is initiated.

In the embodiment of the present disclosure, the terminal device may initiate the random access after the end of the time domain range, send a random access message to the network device, and respond to the paging message sent by the network device.

In some embodiments, the terminal device may send a random access message to the network device on a random access occasion specified by a protocol or configured by the network device after the end of the time domain range, in response to the paging message sent by the network device.

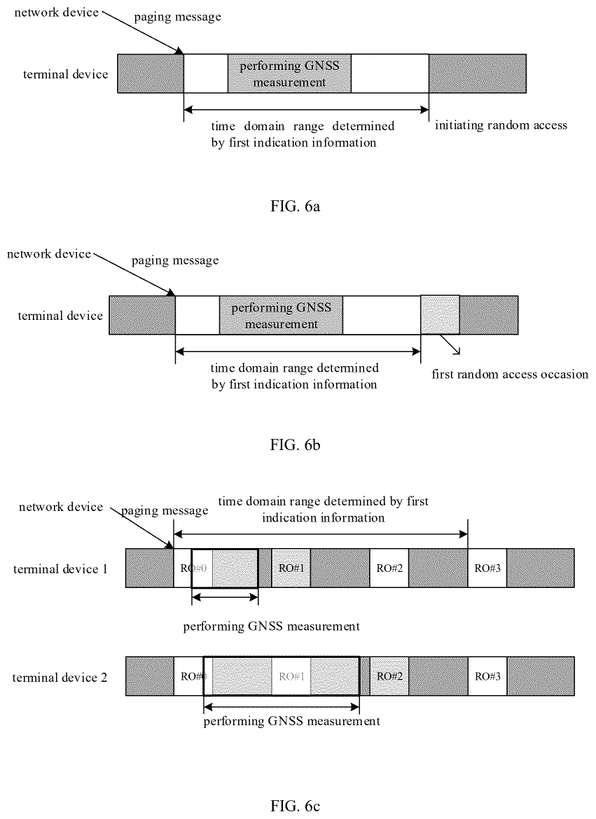

As an example, referring to FIG. 6a, FIG. 6a is a schematic diagram of a method for GNSS positioning measurement provided by an embodiment of the present disclosure. As shown in FIG. 6a, the network device sends a paging message to the terminal device. After receiving the paging message, the terminal device determines the time domain range for performing GNSS measurement according to the time domain range information (starting position, ending position, duration (time length), etc.) indicated by the first indication information in the paging message. The terminal device may perform the GNSS measurement on any time domain position within the time domain range according to its own capability and implementation situation. Within the time domain, the terminal device may stop monitoring the paging message sent by the network device, and the network device also stops sending the paging message to the terminal device within the time domain. After the end of the time domain range, the terminal device may initiate the random access, send a random access message to the network device, and respond to the paging from the network device.

In summary, a paging message sent by a network device is received, the paging message includes first indication information indicating at least one of the following: the starting position of the time domain range, the ending position of the time domain range, and the duration of the time domain range, according to the first indication information, the positioning measurement is performed within the time domain range, the monitoring of the paging message sent by the network device is stopped within the time domain range, and after the end of the time domain range, the random access is initiated, such that the terminal device may timely and effectively acquire its own position information in the idle state, thereby effectively reducing transmission latency, saving power consumption of the terminal device, and avoiding unnecessary paging signaling overhead caused by the terminal device not responding to the paging message in time, which effectively saves the signaling overhead of the system and improves the communication efficiency of the system.

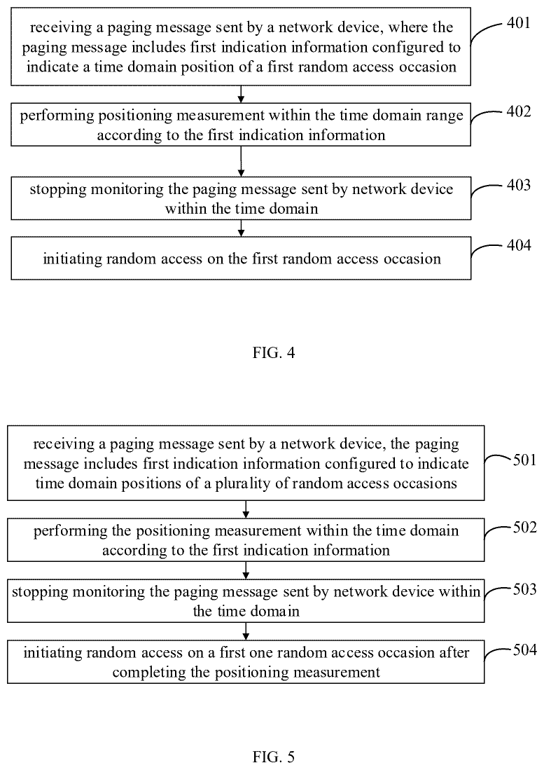

Referring to FIG. 4, FIG. 4 is a flowchart of a method for GNSS positioning measurement provided in an embodiment of the present disclosure. It should be noted that the method for global navigation satellite system GNSS positioning measurement of the embodiment of the present disclosure is performed by a terminal device. The method may be performed independently or in combination with any other embodiment of the present disclosure. As shown in FIG. 4, the method may include the following steps 401-404:
in step 401: a paging message sent by a network device is received, the paging message includes first indication information configured to indicate a time domain position of a first random access occasion.

A starting position of the time domain range where the terminal device performs the positioning measurement is a time domain position where the paging message is received, and an ending position of the time domain range is a time domain position of the first random access occasion.

In the embodiment of the present disclosure, the terminal device receives a paging message sent by the network device and performs the positioning measurement after receiving the paging message. It should be noted that in the embodiments of the present disclosure, the terminal device is in an idle state.

In the embodiment of the present disclosure, the first indication information in the paging message is configured to indicate the time domain position of the first random access occasion. The terminal device may determine the starting position of the time domain range to perform the positioning measurement according to the first indication information as the time domain position where the paging message is received, and the ending position as the time domain position of the first random access occasion.

In step 402, positioning measurement is performed within the time domain range according to the first indication information.

In the embodiment of the present disclosure, the terminal device performs the positioning measurement within the time domain determined according to the first indication information in the paging message after receiving the paging message.

In the embodiments of the present disclosure, the terminal device may perform the positioning measurement on any time domain position within the time domain range according to its own capability and implementation situation.

In step 403: monitoring of the paging message sent by network device within the time domain is stopped.

In the embodiment of the present disclosure, the terminal device may stop monitoring the paging message sent by the network device within the time domain range determined by the first indication information in the paging message, and no longer receive the paging message sent by the network device within the time domain range.

In step 404, random access is initiated on the first random access occasion.

In the embodiment of the present disclosure, the terminal device may initiate the random access on the first random access occasion indicated by the first indication information, send a random access message to the network device, and respond to the paging message sent by the network device.

As an example, referring to FIG. 6b, FIG. 6 is a schematic diagram of a method for GNSS positioning measurement provided by an embodiment of the present disclosure. As shown in FIG. 6b, the network device sends a paging message to the terminal device. After receiving the paging message, the terminal device determines the time domain range for performing the GNSS measurement according to the time domain position of a first RO indicated by the first indication information in the paging message. The starting position of the time domain range is the time domain position where the paging message is received, and the ending position is the time domain position of the first RO. The terminal device may perform the GNSS measurement on any time domain position within the time domain range according to its own capability and implementation situation. Within the time domain, the terminal device may stop monitoring the paging message sent by the network device, and the network device also stops sending the paging message to the terminal device within the time domain. The terminal device may initiate the random access on the first RO, send the random access message to the network device on the first RO, and respond to the paging from the network device.

In summary, the paging message sent by the network device is received, the paging message includes the first indication information, which is configured to indicate the time domain position of the first random access occasion, according to the first indication information, the positioning measurement is performed within the time domain range, and the monitoring of the paging message sent by the network device is stopped within the time domain range. The random access is initiated on the first random access occasion, such that the terminal device may timely and effectively acquire its own position information in the idle state, thereby effectively reducing transmission latency, saving power consumption of the terminal device, and avoiding unnecessary paging signaling overhead caused by the terminal device not responding to the paging message in time, which effectively saves the signaling overhead of the system and improves the communication efficiency of the system.

Referring to FIG. 5, FIG. 5 is a flowchart of a method for GNSS positioning measurement provided in an embodiment of the present disclosure. It should be noted that the method for the global navigation satellite system GNSS positioning measurement of the embodiment of the present disclosure is performed by a terminal device. The method may be performed independently or in combination with any other embodiment of the present disclosure. As shown in FIG. 5, the method may include the following steps 501-504:
in step 501: a paging message sent by a network device is received, the paging message includes first indication information configured to indicate time domain positions of a plurality of random access occasions.
a starting position of the time domain range is a time domain position where the paging message is received, and an ending position of the time domain range is a time domain position of a last one random access occasion of the plurality of random access occasions.

In the embodiment of the present disclosure, the terminal device receives a paging message sent by the network device and performs the positioning measurement after receiving the paging message. It should be noted that in the embodiments of the present disclosure, the terminal device is in an idle state.

In the embodiment of the present disclosure, the first indication information in the paging message is configured to indicate the time domain positions of the plurality of random access occasions. The terminal device may determine the starting position of the time domain range for performing the positioning measurement according to the first indication information as the time domain position where the paging message is received, and the ending position as the time domain position of the last one random access occasion of the plurality of random access occasions.

In step 502, the positioning measurement is performed within the time domain according to the first indication information.

In the embodiment of the present disclosure, the terminal device performs the positioning measurement within the time domain determined according to the first indication information in the paging message after receiving the paging message.

In the embodiments of the present disclosure, the terminal device may perform the positioning measurement on any time domain position within the time domain range according to its own capability and implementation situation.

In step 503: monitoring of the paging message sent by network device within the time domain is stopped.

In the embodiment of the present disclosure, the terminal device may stop monitoring the paging message sent by the network device within the time domain range determined by the first indication information in the paging message, and no longer receive the paging message sent by the network device within the time domain range.

In step 504, random access is initiated on a first one random access occasion after the positioning measurement is completed.

In the embodiments of the present disclosure, the terminal device may perform the positioning measurement on any time domain position within the time domain range according to its own capability. Among the plurality of random access occasions indicated by the first indication information, the terminal device may initiate the random access on the first one random access occasion after the completion of the positioning measurement, send a random access message to the network device, and respond to the paging message sent by the network device.

It may be understood that in the embodiments of the present disclosure, the random access occasion initiated by the terminal device may reflect the positioning measurement capability of the terminal device. The stronger the positioning measurement capability of the terminal device, the shorter the time required to perform the positioning measurement, and the earlier the random access occasion in which the random access may be initiated.

As an example, referring to FIG. 6c, FIG. 6c is a schematic diagram of a method for GNSS positioning measurement provided by an embodiment of the present disclosure. As shown in FIG. 6c, the network device sends a paging message to the terminal device. After receiving the paging message, the terminal device determines the time domain range for performing the GNSS measurement according to the time domain positions (such as RO #0-RO #3 in the figure) of the plurality of ROs indicated by the first indication information in the paging message. The starting position of the time domain range is the time domain position where the paging message is received, and the ending position is the time domain position of the last one RO (i.e. RO #3 in the figure) of the plurality of ROs. The terminal device may perform the GNSS measurement on any time domain position within the time domain range according to its own capability and implementation situation. Within the time domain, the terminal device may stop monitoring the paging message sent by the network device, and the network device may also stop sending the paging message to the terminal device within the time domain. The terminal device may initiate the random access on the first one RO after completing the positioning measurement, send the random access message to the network device, and respond to the paging from the network device. For example, in FIG. 6c, the first one RO after the terminal device 1 completes the positioning measurement is RO #1, and the terminal device 1 may initiate the random access on RO #1. The first one RO after the terminal device 2 completes the positioning measurement is RO #2, and the terminal device 2 may initiate the random access on RO #2. It may be understood that the random access occasion where the terminal device initiates the random access may reflect that the positioning measurement capability of the terminal device 1 is stronger than the positioning measurement capability of the terminal device 2.

In summary, the paging message sent by the network device is received, the paging message includes the first indication information configured to indicate the time domain positions of the plurality of random access occasions. According to the first indication information, the positioning measurement is performed within the time domain range, and the monitoring of the paging message sent by the network device is stopped within the time domain range. On the first one random access occasion after the positioning measurement is completed, the random access is initiated, such that the terminal device may timely and effectively acquire its own position information in the idle state, thereby effectively reducing transmission latency, saving power consumption of the terminal device, and avoiding unnecessary paging signaling overhead caused by the terminal device not responding to the paging message in time, which effectively saves the signaling overhead of the system and improves the communication efficiency of the system.

Referring to FIG. 7, FIG. 7 is a flowchart of a method for GNSS positioning measurement provided in an embodiment of the present disclosure. It should be noted that the method for the GNSS positioning measurement of the embodiment of the present disclosure is performed by a network device. The method may be performed independently or in combination with any other embodiment of the present disclosure. As shown in FIG. 7, the method may include the following step 701:

In step 701: a paging message is sent to a terminal device, the paging message includes first indication information configured to determine time domain range information for the terminal device to perform positioning measurement.

In the embodiment of the present disclosure, the network device sends a paging message to the terminal device, and the terminal device may perform the positioning measurement after receiving the paging message. It should be noted that in the embodiments of the present disclosure, the terminal device is in an idle state.

The paging message includes the first indication information, which is configured to determine the time domain range information when the terminal device performs the positioning measurement. That is, the terminal device may perform the positioning measurement within the time domain range determined by the first indication information. The terminal device may perform the positioning measurement on any time domain position within the time domain range according to its own positioning measurement capability and implementation situation.

In the embodiment of the present disclosure, within the time domain range determined by the first indication information, the network device may stop sending the paging message to the terminal device, thereby avoiding unnecessary signaling overhead caused by the terminal device's inability to respond to the paging in time.

In some embodiments, the first indication information is configured to indicate at least one of the following: a starting position of the time domain range, an ending position of the time domain range, or a duration of the time domain range. The terminal device may determine the time domain range for performing positioning measurement according to the first indication information.

In some embodiments, the network device may monitor a random access message sent by the terminal device after the end of the time domain range.

As an example, referring to FIG. 6a, the network device sends a paging message to the terminal device. After receiving the paging message, the terminal device determines the time domain range for performing GNSS measurement according to the time domain range information (starting position, ending position, duration (time length), etc.) indicated by the first indication information in the paging message. The terminal device may perform the GNSS measurement on any time domain position within the time domain range according to its own capability and implementation situation. Within the time domain, the terminal device may stop monitoring the paging message sent by the network device, and the network device may also stop sending the paging message to the terminal device within the time domain. After the end of the time domain range, the terminal device may initiate the random access, send a random access message to the network device, and respond to the paging from the network device, and after the end of the time domain range, the network device monitors the random access message sent by the terminal device.

In some embodiments, the first indication information is configured to indicate the time domain position of the first random access occasion. The starting position of the time domain range determined by the first indication information is the time domain position where the paging message is received, and the ending position of the time domain range is the time domain position of the first random access occasion.

In some embodiments, the network device may monitor the random access message sent by the terminal device after the first RO.

As an example, referring to FIG. 6b, the network device sends a paging message to the terminal device. After receiving the paging message, the terminal device determines the time domain range for performing the GNSS measurement according to the time domain position of a first RO indicated by the first indication information in the paging message. The starting position of the time domain range is the time domain position where the paging message is received, and the ending position is the time domain position of the first RO. The terminal device may perform the GNSS measurement on any time domain position within the time domain range according to its own capability and implementation situation. Within the time domain, the terminal device may stop monitoring the paging message sent by the network device, and the network device may also stop sending the paging message to the terminal device within the time domain. The terminal device may initiate the random access on the first RO, send the random access message to the network device on the first RO, and respond to the paging from the network device. After the first RO, the network device monitors the random access message sent by the terminal device.

In some embodiments, the first indication information is configured to indicate time domain positions of a plurality of random access occasions. A starting position of the time domain range determined by the first indication information is a time domain position where the paging message is received, and an ending position of the time domain range is a time domain position of a last one RO of the plurality of ROs.

In some embodiments, the network device may monitor a random access message sent by the terminal device after a first one RO in the plurality of ROs.

As an example, referring to FIG. 6c, the network device sends a paging message to the terminal device. After receiving the paging message, the terminal device determines the time domain range for performing the GNSS measurement according to the time domain positions (such as RO #0-RO #3 in the figure) of the plurality of ROs indicated by the first indication information in the paging message. The starting position of the time domain range is the time domain position where the paging message is received, and the ending position is the time domain position of the last one RO (such as RO #3 in the figure) of the plurality of ROs. The terminal device may perform the GNSS measurement on any time domain position within the time domain range according to its own capability and implementation situation. Within the time domain, the terminal device may stop monitoring the paging message sent by the network device, and the network device may also stop sending the paging message to the terminal device within the time domain. The terminal device may initiate the random access on the first one RO after completing the positioning measurement, send the random access message to the network device, and respond to the paging from the network device. The network device may monitor the random access message sent by the terminal device after the first one RO (such as RO #0 in the figure) of the plurality of ROs. The network device may determine the positioning measurement capability of the terminal device according to the time domain position of the random access initiated by terminal device. For example, in FIG. 6c, the network device monitors the random access message sent by the terminal device after RO #0, and monitors that terminal device 1 initiates the random access on RO #1 and terminal device 2 initiates the random access on RO #2. It may be understood that network device may determine that the positioning measurement capability of the terminal device 1 is stronger than that of the terminal device 2 according to the time domain position of the random access initiated by the terminal device.

In summary, a paging message is sent to the terminal device, the paging message includes the first indication information configured to determine the time domain range information for the terminal device to perform the positioning measurement, such that the terminal device may timely and effectively acquire its own position information in the idle state, thereby effectively reducing transmission latency, saving power consumption of the terminal device, and avoiding unnecessary paging signaling overhead caused by the terminal device not responding to the paging message in time, which effectively saves the signaling overhead of the system and improves the communication efficiency of the system.

Corresponding to the method for GNSS positioning measurement provided in the above embodiments, the present disclosure also provides an apparatus for GNSS positioning measurement. As the apparatus for GNSS positioning measurement provided in the present disclosure corresponds to the method provided in the above embodiments, the implementation of the method for GNSS positioning measurement is also applicable to the apparatus for GNSS positioning measurement provided in the following embodiments, and will not be described in detail in the following embodiments.

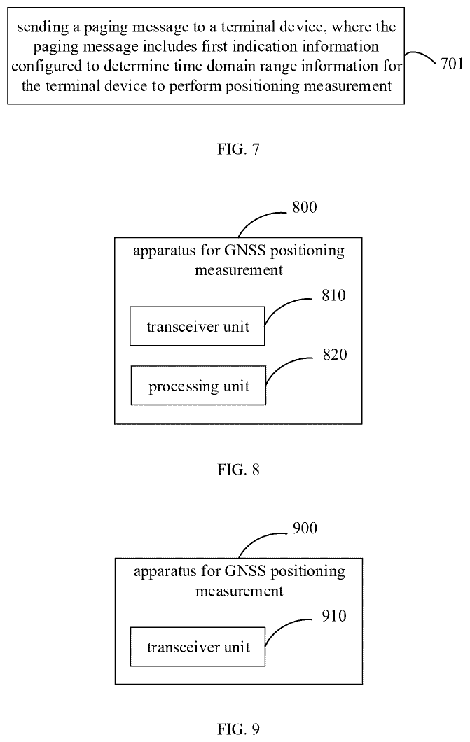

Referring to FIG. 8, FIG. 8 is a structural diagram of an apparatus for global navigation satellite system GNSS positioning measurement provided in an embodiment of the present disclosure.

As shown in FIG. 8, the apparatus 800 for global navigation satellite system GNSS positioning measurement includes a transceiver unit 810 and a processing unit 820, where:
the transceiver unit 810 is configured to receive a paging message sent by a network device;
the paging message includes first indication information, and the first indication information is configured to determine time domain range information for the terminal device to perform positioning measurement;
a processing unit 820 is configured to perform the positioning measurement within a time domain range according to the first indication information.

In some embodiments, the first indication information is configured to indicate at least one of the following:
a starting position of the time domain range;
an ending position of the time domain range; or
a duration of the time domain range.

In some embodiments, the transceiver unit 810 is further configured to:
initiate random access after and end of the time domain range.

In some embodiments, the first indication information is configured to indicate a time domain position of the first random access occasion;
a starting position of the time domain range is a time domain position where the paging message is received, and an ending position of the time domain range is the time domain position of the first random access occasion.

In some embodiments, the transceiver unit 810 is further configured to:
initiate random access on the first random access occasion.

In some embodiments, the first indication information is configured to indicate time domain positions of a plurality of random access occasions;
a starting position of the time domain range is a time domain position where the paging message is received, and an ending position of the time domain range is a time domain position of a last one random access occasion of the plurality of random access occasions.

In some embodiments, the transceiver unit 810 is further configured to:
initiate random access on a first one random access occasion after the positioning measurement is completed.

In some embodiments, the transceiver unit 810 is further configured to:
stop monitoring the paging message sent by the network device within the time domain.

The apparatus for global navigation satellite system GNSS positioning measurement of the embodiments may receive the paging message sent by the network device, the paging message includes the first indication information, which is configured to determine the time domain range information for the terminal device to perform positioning measurement, and according to the first indication information, the positioning measurement is performed within the time domain range, such that the terminal device may timely and effectively acquire its own position information in the idle state, thereby effectively reducing transmission latency, saving power consumption of the terminal device, and avoiding unnecessary paging signaling overhead caused by the terminal device not responding to the paging message in time, which effectively saves the signaling overhead of the system and improves the communication efficiency of the system.

Referring to FIG. 9, FIG. 9 is a structural diagram of an apparatus for global navigation satellite system GNSS positioning measurement provided in an embodiment of the present disclosure.

As shown in FIG. 9, the apparatus for global navigation satellite system GNSS positioning measurement 900 includes a transceiver unit 910, where:
the transceiver unit 910 is configured to send a paging message to a terminal device;
the paging message includes first indication information configured to determine time domain range information for the terminal device to perform positioning measurement.

In some embodiments, the first indication information is configured to indicate at least one of the following:
a starting position of a time domain range;
an ending position of a time domain range; or
a duration of a time domain range.

In some embodiments, the transceiver unit 910 is further configured to:
monitor a random access message sent by the terminal device after an end of the time domain range.

In some embodiments, the first indication information is configured to indicate a time domain position of the first random access occasion;
a starting position of a time domain range is a time domain position where the paging message is received, and an ending position of the time domain range is the time domain position of the first random access occasion.

In some embodiments, the transceiver unit 910 is further configured to:
monitor a random access message sent by the terminal device after the first random access occasion.

In some embodiments, the first indication information is configured to indicate the time domain positions of a plurality of random access occasions;

a starting position of a time domain range is a time domain position where the paging message is received, and an ending position of the time domain range is a time domain position of a last one random access occasion of the plurality of random access occasions.

In some embodiments, the transceiver unit 910 is further configured to:
monitor a random access message sent by the terminal device after a first one random access occasion of at least one random access occasion.

In some embodiments, the transceiver unit 910 is further configured to:
stop sending the paging message to the terminal device within the time domain.

The apparatus for global navigation satellite system GNSS positioning measurement of this embodiment may send the paging message to the terminal device, the paging message includes the first indication information configured to determine the time domain range information for the terminal device to perform the positioning measurement, such that the terminal device may timely and effectively acquire its own position information in the idle state, thereby effectively reducing transmission latency, saving power consumption of the terminal device, and avoiding unnecessary paging signaling overhead caused by the terminal device not responding to the paging message in time, which effectively saves the signaling overhead of the system and improves the communication efficiency of the system.

In order to implement the above embodiments, the present disclosure also proposes a communication apparatus including a processor and a memory, the memory stores a computer program, and the processor executes the computer program stored in the memory to cause the apparatus to perform the method shown in the embodiments of FIGS. 2 to 5.

In order to implement the above embodiments, the present disclosure also proposes a communication apparatus including a processor and a memory, the memory stores a computer program, and the processor executes the computer program stored in the memory to cause the apparatus to perform the method shown in the embodiment of FIG. 7.

In order to implement the above embodiments, the present disclosure also proposes a communication apparatus including a processor and an interface circuit, where the interface circuit is configured to receive code instructions and transmit the code instructions to the processor, and the processor is configured to run the code instructions to execute the method shown in the embodiments of FIGS. 2 to 5.

In order to implement the above embodiments, the present disclosure also proposes a communication apparatus including a processor and an interface circuit, where the interface circuit is configured to receive code instructions and transmit the code instructions to the processor, and the processor is configured to run the code instructions to execute the method shown in the embodiment of FIG. 7.

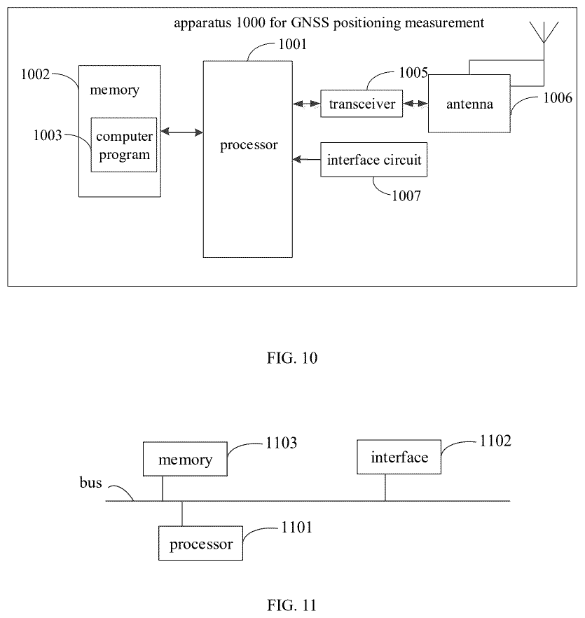

Referring to FIG. 10, FIG. 10 is a structural diagram illustrating another apparatus for global navigation satellite system GNSS positioning measurement according to embodiments of the present disclosure. The apparatus 1000 for global navigation satellite system GNSS positioning measurement may be a network device, a terminal device, a chip, a system on chip or a processor that supports the network device to implement the method, or a chip, a system on chip or a processor that supports the terminal device to implement the method. The apparatus may be configured to implement the method described in the method embodiments, and may refer to descriptions in the method embodiments.

The apparatus 1000 for global navigation satellite system GNSS positioning measurement may include one or more processors 1001. The processor 1001 may include a general purpose processor or a dedicated processor. For example, the processor may be a baseband processor or a central processor. The baseband processor may be configured to process a communication protocol and communication data, and the central processor may be configured to control an apparatus for global navigation satellite system GNSS positioning measurement (e.g., a base station, a baseband chip, a terminal device, a terminal device chip, a DU or a CU, etc.), to execute a computer program, and process data of the computer program.

In some embodiments, the apparatus 1000 for global navigation satellite system GNSS positioning measurement may further include one or more memories 1002 storing a computer program 1003. The processor 1001 executes the computer program 1003 such that the apparatus 1000 for global navigation satellite system GNSS positioning measurement performs the method as described in the above method embodiments. The computer program 1003 may be solidified in the processor 1001, in which case the processor 1001 may be implemented by hardware.

In some embodiments, the memory 1002 may further store data. The apparatus 1000 for global navigation satellite system GNSS positioning measurement and the memory 1002 may be independently configured or integrated together.

In some embodiments, the apparatus 1000 for global navigation satellite system GNSS positioning measurement may further include a transceiver 1005 and an antenna 1006. The transceiver 1005 may be referred to as a transceiving unit, a transceiver or a transceiving circuit, which may be configured to achieve a transceving function. The transceiver 1005 may include a receiver and a transmitter. The receiver may be referred to as a receiver or a receiving circuit, etc., for implementing a receiving function; the transmitter may be referred to as a transmitter or a transmission circuit, etc. for implementing a transmitting function.

In some embodiments, the apparatus 1000 for global navigation satellite system GNSS positioning measurement may further include one or more interface circuits 1007. The interface circuit 1007 is configured to receive code instructions and transmit the code instructions to the processor 1001. The processor 1001 runs the code instructions such that the apparatus 1000 for global navigation satellite system GNSS positioning measurement performs the method according to the above method embodiment.

In an implementation, the processor 1001 may include a transceiver for implementing receiving and transmitting functions. For example, the transceiver may be a transceiving circuit, or an interface, or an interface circuit. The transceiving circuit, the interface or the interface circuit for implementing receiving and transmitting functions may be separate or integrated together. The transceiving circuit, the interface or the interface circuit may be configured to read and write codes/data, or the transceiving circuit, the interface or the interface circuit may be configured to transmit or deliver a signal.

In an implementation, the apparatus 1000 for global navigation satellite system GNSS positioning measurement may include a circuit that may implement a transmitting or receiving or communication function in the above method embodiments. The processor and the transceiver described in the present disclosure may be implemented on integrated circuits (ICs), analog ICs, radio frequency integrated circuits (RFICs), mixed signal ICs, application specific integrated circuits (ASICs), printed circuit boards (PCBs), electronic devices, etc. The processor and the transceiver may further be fabricated by using various IC process technologies, such as complementary metal oxide semiconductor (CMOS), nMetal-oxide-semiconductor (NMOS), positive channel metal oxide semiconductor (PMOS), bipolar junction transistor(BJT), bipolar CMOS(BiCMOS), silicon germanium(SiGe) and gallium arsenide(GaAs).

The apparatus for global navigation satellite system GNSS positioning measurement described in the above embodiments may be a network device or a terminal device, but the scope of the apparatus for global navigation satellite system GNSS positioning measurement described in the present disclosure is not limited thereto, and a structure of the apparatus for global navigation satellite system GNSS positioning measurement may not be subject to FIG. 8-FIG. 9. The apparatus for global navigation satellite system GNSS positioning measurement may be a stand-alone device or may be a part of a larger device. For example, the apparatus for global navigation satellite system GNSS positioning measurement may be:
(1) a stand-alone integrated circuit (IC), or a chip, or a system on chip or a subsystem;
(2) a set of one or more ICs, in some embodiments, which may also include a storage component for storing data and a computer program;
(3) an ASIC, such as a Modem;
(4) a module that may be embedded within other devices;
(5) a receiver, a terminal device, a smart terminal device, a cellular phone, a wireless device, a handset, a mobile unit, a vehicle device, a network device, a cloud device, an artificial intelligence device, etc. ; and
(6) others, and so forth.

In the case that the apparatus for global navigation satellite system GNSS positioning measurement may be a chip or a system on chip, please refer to a diagram of a structure of a chip as illustrated in FIG. 11. The chip illustrated in FIG. 11 may include a processor 1101 and an interface 1102. There may be one or more processors 1101, and there may be a plurality of interfaces 1102.

In the case that the chip is configured to implement a function of a network device in embodiments of the present disclosure:
the interface 1102 is configured for coding instructions and transferring the coding instructions to the processor.
the processor 1101 is configured to run the code instructions to perform the method according to FIGS. 2 to 5.

In the case that the chip is configured to implement a function of a terminal device in embodiments of the present disclosure:
the interface 1102 is configured for coding instructions and transferring the coding instructions to the processor.
the processor 1101 is configured to run the code instructions to perform the method according to FIG. 7.

In some embodiments, the chip also includes a memory 1103 for storing a necessary computer program and data.

Those skilled in the related art may understand that, various illustrative logical blocks and steps listed in embodiments of the present disclosure, may be implemented by an electronic hardware, a computer software or a combination of an electronic hardware and a computer software. Whether the function is implemented by the hardware or the software depends on specific applications and design requirements for an overall system. Those skilled in the art may implement the functions by using various methods for each specific application, but such an implementation should not be understood as beyond the protection scope of embodiments of the present disclosure.

A communication system is further provided in the embodiments of the present disclosure. The system includes an apparatus for global navigation satellite system GNSS positioning measurement as a terminal device and an apparatus for global navigation satellite system GNSS positioning measurement as a network device in the embodiments shown in FIGS. 8-9. Alternatively, the system includes an apparatus for global navigation satellite system GNSS positioning measurement as a terminal device and an apparatus for global navigation satellite system GNSS positioning measurement as a network device in the embodiment shown in FIG. 10.

A computer-readable storage medium storing instructions is further provided in the present disclosure. When the instructions are executed, functions of the any one method embodiment are implemented.

A computer program product is further provided. The computer program product implements functions of the above any one method embodiment when executed by a processor.

In the above embodiments, the functions may be wholly or partially implemented by a software, a hardware, a firmware, or any combination thereof. When implemented by a software, the functions may be implemented in whole or in part in the form of a computer program product. The computer program product includes one or more computer programs. Procedures or functions according to embodiments of the present disclosure are wholly or partially generated when the computer program is loaded and executed on a computer. The computer may be a general purpose computer, a special purpose computer, a computer network, or other programmable device. The computer program may be stored in a computer-readable storage medium or transmitted from one computer-readable storage medium to another. For example, the computer program may be transmitted from one website, computer, server, or data center to another via wire (such as a coaxial cable, a fiber optic, a digital subscriber line (DSL)) or wireless (such as infrared, wireless, microwave). The computer-readable storage medium may be any available medium that may be accessed by a computer or a data storage device such as a server that integrates one or more of the available media, and a data center. The readable medium may be a magnetic medium (such as a floppy disk, a hard disk and a magnetic tape), an optical medium (such as a digital video disk (DVD)), or a semiconductor medium (such as a solid state disk (SSD)).

Those skilled in the art may understand that various numbers such as first and second involved in the present disclosure are distinguished merely for convenience of description, and are not intended to limit the scope of embodiments of the present disclosure, but also to indicate an order of precedence.

At least one in the present disclosure may also be described as one or more, and a plurality of may be two, three, four or more, which is not limited in the present disclosure. In embodiments of the present disclosure, for a kind of technical feature, technical features in the kind of technical feature are distinguished by “first,” “second,” “third,” “A,” “B,” “C” and “D,” and there is no order of precedence or magnitude between technical features described in “first,” “second,” “third,” “A,” “B,” “C” and “D”.

Corresponding relationships indicated by tables in the present disclosure may be configured or predefined. Values of information in tables are only examples, and may be configured as other values, which are not limited in the present disclosure. When corresponding relationships between information and parameters are configured, it is not always necessary to configure all corresponding relationships indicated in tables. For example, in the tables in the present disclosure, corresponding relationships indicated by some rows may not be configured. For another example, appropriate transformations and adjustments, such as splitting and merging, may be made based on the above tables. Names of parameters shown in headers in the tables may be other names understandable by the apparatus for global navigation satellite system GNSS positioning measurement, and values or representations of the parameters may be other values or representations understandable by the apparatus for global navigation satellite system GNSS positioning measurement. When the above tables are implemented, other data structures may be used, and for example, arrays, queues, containers, stacks, linear lists, pointers, linked lists, trees, graphs, structures, classes, heaps or hash tables may be used.

Pre-defined in the present disclosure may be understood as defined, pre-defined, stored, pre-stored, pre-negotiated, pre-configured, solidified or pre-fired.

Those skilled in the related art may realize that, in combination with units and algorithm steps of the examples described in embodiments of the present disclosure, may be implemented by an electronic hardware or a combination of an electronic hardware and a computer software. Whether the functions are executed by the hardware or the software depends on a specific application and a design constraint of the technical solution. Those skilled in the art may adopt different methods for each specific application to implement the described functions, but such implementation should not be considered beyond the scope of the present disclosure.

A first aspect of embodiments of the present disclosure proposes a method for global navigation satellite system GNSS positioning measurement, performed by a terminal device and including:
receiving a paging message sent by a network device;
where the paging message includes first indication information, and the first indication information is configured to determine time domain range information for the terminal device to perform positioning measurement; and
performing, according to the first indication information, the positioning measurement within a time domain range.

In some embodiments, the first indication information is configured to indicate at least one of following:
a starting position of the time domain range; an ending position of the time domain range; or a duration of the time domain range.

In some embodiments, the method further includes: initiating random access after and end of the time domain range.

In some embodiments, the first indication information is configured to indicate a time domain position of a first random access occasion;
a starting position of the time domain range is a time domain position where the paging message is received, and an ending position of the time domain range is the time domain position of the first random access occasion.

In some embodiments, the method further includes: initiating random access on the first random access occasion.

In some embodiments, the first indication information is configured to indicate time domain positions of a plurality of random access occasions;
a starting position of the time domain range is a time domain position where the paging message is received, and an ending position of the time domain range is a time domain position of a last one random access occasion of the plurality of random access occasions.

In some embodiments, the method further includes: initiating random access on a first one random access occasion after the positioning measurement is completed.

In some embodiments, the method further includes: stopping monitoring the paging message sent by the network device within the time domain.

A second aspect of embodiments of the present disclosure proposes a method for global navigation satellite system GNSS positioning measurement, performed by a network device and including:
sending a paging message to a terminal device;
where the paging message includes first indication information, and the first indication information is configured to determine time domain range information for the terminal device to perform positioning measurement.

In some embodiments, the first indication information is configured to indicate at least one of following:
a starting position of a time domain range; an ending position of a time domain range; or a duration of a time domain range.

In some embodiments, the method further includes: monitoring a random access message sent by the terminal device after and end of the time domain range.

In some embodiments, the first indication information is configured to indicate a time domain position of a first random access occasion;

a starting position of a time domain range is a time domain position where the paging message is received, and an ending position of the time domain range is the time domain position of the first random access occasion.

In some embodiments, the method further includes: monitoring a random access message sent by the terminal device after the first random access occasion.

In some embodiments, the first indication information is configured to indicate time domain positions of a plurality of random access occasions;
a starting position of a time domain range is a time domain position where the paging message is received, and an ending position of the time domain range is a time domain position of a last one random access occasion of the plurality of random access occasions.

In some embodiments, the method further includes: monitoring a random access message sent by the terminal device after a first one random access occasion of at least one random access occasion.

In some embodiments, the method further includes: stopping sending the paging message to the terminal device within the time domain.

A third aspect of embodiments of the present disclosure proposes an apparatus for global navigation satellite system GNSS positioning measurement, including:
a transceiver unit, configured to receive a paging message sent by a network device;
the paging message includes first indication information, and the first indication information is configured to determine time domain range information for the terminal device to perform positioning measurement; and
a processing unit, configured to perform the positioning measurement within a time domain range according to the first indication information.

In some embodiments, the first indication information is configured to indicate at least one of the following:
a starting position of the time domain range; an ending position of the time domain range; or a duration of the time domain range.

In some embodiments, the transceiver unit is further configured to:
initiate random access after and end of the time domain range.

In some embodiments, the first indication information is configured to indicate a time domain position of the first random access occasion;
a starting position of the time domain range is a time domain position where the paging message is received, and an ending position of the time domain range is the time domain position of the first random access occasion.

In some embodiments, the transceiver unit 810 is further configured to:
initiate random access on the first random access occasion.

In some embodiments, the first indication information is configured to indicate time domain positions of a plurality of random access occasions;
a starting position of the time domain range is a time domain position where the paging message is received, and an ending position of the time domain range is a time domain position of a last one random access occasion of the plurality of random access occasions.

In some embodiments, the transceiver unit is further configured to:
initiate random access on a first one random access occasion after the positioning measurement is completed.

In some embodiments, the transceiver unit is further configured to:
stop monitoring the paging message sent by the network device within the time domain.

A fourth aspect of embodiments of the present disclosure proposes an apparatus for global navigation satellite system GNSS positioning measurement, including:
a transceiver unit, configured to send a paging message to a terminal device;
the paging message includes first indication information configured to determine time domain range information for the terminal device to perform positioning measurement.

In some embodiments, the first indication information is configured to indicate at least one of the following:
a starting position of a time domain range; an ending position of a time domain range; or a duration of a time domain range.

In some embodiments, the transceiver unit is further configured to:
monitor a random access message sent by the terminal device after an end of the time domain range.

In some embodiments, the first indication information is configured to indicate a time domain position of the first random access occasion;
a starting position of a time domain range is a time domain position where the paging message is received, and an ending position of the time domain range is the time domain position of the first random access occasion.

In some embodiments, the transceiver unit is further configured to:
monitor a random access message sent by the terminal device after the first random access occasion.

In some embodiments, the first indication information is configured to indicate the time domain positions of a plurality of random access occasions;
a starting position of a time domain range is a time domain position where the paging message is received, and an ending position of the time domain range is a time domain position of a last one random access occasion of the plurality of random access occasions.

In some embodiments, the transceiver unit is further configured to:
monitor a random access message sent by the terminal device after a first one random access occasion of at least one random access occasion.

In some embodiments, the transceiver unit is further configured to:
stop sending the paging message to the terminal device within the time domain.

A fifth aspect of embodiments of the present disclosure proposes a communication apparatus, including a processor and a memory, where the memory stores a computer program, and the processor executes the computer program stored in the memory to cause the apparatus to perform the method for global navigation satellite system GNSS positioning measurement according to the embodiments of the first aspect.

A sixth aspect of embodiments of the present disclosure proposes a communication apparatus, including a processor and a memory, where the memory stores a computer program, and the processor executes the computer program stored in the memory to cause the apparatus to perform the method for global navigation satellite system GNSS positioning measurement according to the embodiments of the second aspect.

A seventh aspect of embodiments of the present disclosure proposes a communication apparatus, including: a processor and an interface circuit; where the interface circuit is configured to receive code instructions and transmit the code instructions to the processor; and the processor is configured to run the code instructions to execute method for global navigation satellite system GNSS positioning measurement according to the embodiments of the first aspect.

A eighth aspect of embodiments of the present disclosure proposes a communication apparatus, including: a processor and an interface circuit; where the interface circuit is configured to receive code instructions and transmit the code instructions to the processor; and the processor is configured to run the code instructions to execute method for global navigation satellite system GNSS positioning measurement according to the embodiments of the second aspect.

A nineth aspect of embodiments of the present disclosure proposes a computer-readable storage medium storing instructions, where when the instructions are executed, the method for global navigation satellite system GNSS positioning measurement according to the embodiments of the first aspect is implemented.

A tenth aspect of embodiments of the present disclosure proposes a computer-readable storage medium storing instructions, where when the instructions are executed, the method for global navigation satellite system GNSS positioning measurement according to the embodiments of the second aspect is implemented.

An eleventh embodiment of the present disclosure proposes a computer program that, when run on a computer, causes the computer to execute the method described in the embodiments of the first aspect.

A twelfth embodiment of the present disclosure proposes a computer program that, when run on a computer, causes the computer to perform the method for GNSS positioning measurement described in the embodiments of the second aspect.

The embodiments of the present disclosure provide a method and an apparatus for global navigation satellite system GNSS positioning measurement, the paging message sent by the network device is received, the paging message includes the first indication information, which is configured to determine the time domain range information for the terminal device to perform positioning measurement, and according to the first indication information, the positioning measurement is performed within the time domain range, such that the terminal device may timely and effectively acquire its own position information in the idle state, thereby effectively reducing transmission latency, saving power consumption of the terminal device, and avoiding unnecessary paging signaling overhead caused by the terminal device not responding to the paging message in time, which effectively saves the signaling overhead of the system and improves the communication efficiency of the system.

Those skilled in the art may clearly understand that, for the convenience and brevity of description, the specific working processes of the above-described systems, apparatuses, and units may refer to the corresponding processes in the foregoing method embodiments, which will not be repeated herein.

It should be noted that various forms of processes shown above may be used to reorder, add, or delete steps. For example, steps described in embodiments of the present disclosure may be executed in parallel, sequentially, or in a different order, as long as the desired result of the technical solution disclosed in the present disclosure may be achieved, which will not be limited herein.

The above specific implementations do not constitute a limitation to the protection scope of the present disclosure. It should be apparent to those skilled in the art that various modifications, combinations, sub-combinations and alternatives may be made depending on design requirements and other factors. Any modifications, equivalent replacements and improvements made within the spirit and principles of the present disclosure shall be included within the scope of protection of the present disclosure.

1. A method for global navigation satellite system (GNSS) positioning measurement, performed by a terminal device, comprising:
receiving a paging message sent by a network device; wherein the paging message comprises first indication information, and the first indication information is configured to determine time domain range information for the terminal device to perform positioning measurement; and
performing, according to the first indication information, the positioning measurement within a time domain range.

2. The method according to claim 1, wherein the first indication information is configured to indicate at least one of following:
a starting position of the time domain range;
an ending position of the time domain range; or
a duration of the time domain range.

3. The method according to claim 1, further comprising:
initiating random access after and end of the time domain range.

4. The method according to claim 1, wherein the first indication information is configured to indicate a time domain position of a first random access occasion;
a starting position of the time domain range is a time domain position where the paging message is received, and an ending position of the time domain range is the time domain position of the first random access occasion.

5. The method according to claim 4, further comprising:
initiating random access on the first random access occasion.

6. The method according to claim 1, wherein the first indication information is configured to indicate time domain positions of a plurality of random access occasions;
a starting position of the time domain range is a time domain position where the paging message is received, and an ending position of the time domain range is a time domain position of a last one random access occasion of the plurality of random access occasions.

7. The method according to claim 6, further comprising:
initiating random access on a first one random access occasion after the positioning measurement is completed.

8. The method according to claim 1, further comprising:
stopping monitoring the paging message sent by the network device within the time domain.

9. A method for global navigation satellite system (GNSS) positioning measurement, performed by a network device, and comprising:
sending a paging message to a terminal device;
wherein the paging message comprises first indication information, and the first indication information is configured to determine time domain range information for the terminal device to perform positioning measurement.

10. The method according to claim 9, wherein the first indication information is configured to indicate at least one of following:
a starting position of a time domain range;
an ending position of the time domain range; or
a duration of the time domain range.

11. The method according to claim 10, further comprising:
monitoring a random access message sent by the terminal device after and end of the time domain range.

12. The method according to claim 9, wherein the first indication information is configured to indicate a time domain position of a first random access occasion;
a starting position of a time domain range is a time domain position where the paging message is received, and an ending position of the time domain range is the time domain position of the first random access occasion.

13. The method according to claim 12, further comprising:
monitoring a random access message sent by the terminal device after the first random access occasion.

14. The method according to claim 9, wherein the first indication information is configured to indicate time domain positions of a plurality of random access occasions;
a starting position of a time domain range is a time domain position where the paging message is received, and an ending position of the time domain range is a time domain position of a last one random access occasion of the plurality of random access occasions.

15. The method according to claim 14, further comprising:
monitoring a random access message sent by the terminal device after a first one random access occasion of the plurality of random access occasions.

16. The method according to claim 9, further comprising:
stopping sending the paging message to the terminal device within the time domain.

17. (canceled)

18. (canceled)

19. A communication apparatus, comprising:
a processor; and
a memory, wherein the memory stores a computer program,
wherein the computer program when executed by the processor causes the communication apparatus to:
receive a paging message sent by a network device; wherein the paging message comprises first indication information, and the first indication information is configured to determine time domain range information for the communication apparatus to perform positioning measurement; and
perform, according to the first indication information, the positioning measurement within a time domain range.

20. A communication apparatus, comprising:
a processor and
a memory, wherein the memory stores a computer program, and
wherein the computer program when executed by the processor causes the communication apparatus to act as the network device and perform the method according to claim 9.

21.-24. (canceled)

25. The communication apparatus according to claim 19, wherein the first indication information is configured to indicate at least one of following:
a starting position of the time domain range;
an ending position of the time domain range; or
a duration of the time domain range.

26. The communication apparatus according to claim 19, wherein the processor is further configured to:
initiate random access after and end of the time domain range.
